(19) United States
(12) Patent Application Publication
(10) Pub. No.: US 2015/0201615 A1
(43) Pub. Date: Jul. 23, 2015

(54) INSECT REPELLENT SURFACE COMPOSITION

(71) Applicant: TyraTech, Inc., Morrisville, NC (US)

(72) Inventors: Jason Schmidt, Morrisville, NC (US); Christopher Knox, Morrisville, NC (US)

(21) Appl. No.: 14/409,986

(22) PCT Filed: Jun. 28, 2013
(86) PCT No.: PCT/US13/48597

§ 371 Date: Dec. 19, 2014

Related U.S. Application Data
(60) Provisional application No. 61/665,850, filed on Jun. 28, 2012.

(51) Int. Cl. A01N 35/06; A01N 35/04; A01N 31/02; A01N 37/18

(52) U.S. Cl. CPC A01N 35/06; A01N 37/18; A01N 35/04; A01N 31/02

(57) ABSTRACT

Embodiments of the invention relate to a pest-control composition comprising at least one active ingredient and at least two other ingredients; wherein the at least one active ingredient is selected from the group consisting of geraniol, nootketone, amyl cinnamaldehyde, catnip, wintergreen, carvacrol, d-limonene, orange oil, lauric acid, alpha pinene, mint, cornmint oil, lemon oil, eucalyptus, eugenol, peppermint, lemongrass oil, and terpenes; and wherein the at least two other ingredients are selected from the group consisting of 2-propanol, alcohol, ethanol, monobutyl ether, ethylene glycol, terpenes, ethoxylated alcohol, dodecanol, ammonia, soap, lauryl polyglucose, polyethylene glycol, sodium lauryl sulfate, sodium olefin sulfonate, cocamidapropyl betaine, alkylbenzene sulfonate, polyoxyethelene alkylphenol sulfate, sodium dodecyl benzene sulfonate, sodium sterate, potassium sterate, potassium myristate, tomadol, polyglyceryl sterate, glycol monosterate, potassium oleate, polyglyceryl oleate, tween, polymers, acrylic polymers, ethyl cellulous, carboxymethyl cellulose, sodium hydroxide, ammonium hydroxide, polyacrylate polymer, polyvinyl pyrolidane, lauric diethanolamine, dimethyldodecylamine oxide, aspartic acid tetrasodium salt, and sodium citrate.

### CROSS-REFERENCE TO RELATED APPLICATIONS

This application claims priority from U.S. Provisional Application No. 61/665,850, filed on Jun. 28, 2012 and entitled “INSECT REPELLENT SURFACE COMPOSITION,” which is incorporated herein by reference in its entirety.

### FIELD OF THE INVENTION

The invention disclosed herein generally relates to compositions and methods related to controlling insects.

### BACKGROUND OF THE INVENTION

Various chemicals and mixtures have been studied for pesticidal activity for many years with a goal of obtaining a product which is selective for invertebrates such as insects and has little or no toxicity to vertebrates such as mammals, fish, fowl and other species and does not otherwise persist in and damage the environment.

Most of the previously known and commercialized products having sufficient pesticidal activity to be useful also have toxic or deleterious effects on mammals, fish, fowl or other species which are not the target of the product. For example, organophosphorus compounds and carbamates inhibit the activity of acetylcholinesterase in insects as well as in all classes of animals. Chlordimeform and related formamidines are known to act on octopamine receptors of insects but have been removed from the market because of cardiotoxic potential in vertebrates and carcinogenicity in animals and a varied effect on different insects. Other compounds, which can be less toxic to mammals and other non-target species, are sometimes difficult to identify.

### SUMMARY OF THE INVENTION

Embodiments of the invention relate to a pest-control composition comprising at least one active ingredient and at least two other ingredients; wherein the at least one active ingredient is selected from the group consisting of geraniol, nootketone, amyl cinnamaldehyde, catnip, wintergreen, carvacrol, d-limonene, orange oil, lauric acid, alpha pinene, mint, cornmint oil, lemon oil, eucalyptus, eugenol, peppermint, lemongrass oil, and terpenes; and wherein the at least two other ingredients are selected from the group consisting of 2-propanol, alcohol, ethanol, monobutyl ether, ethylene glycol, terpenes, ethoxylated alcohol, dodecanol, ammonia, soap, lauryl polyglucose, polyethylene glycol, sodium lauryl sulfate, sodium olefin sulfonate, cocamidapropyl betaine, alkylbenzene sulfonate, polyoxyethelene alkylphenol sulfate, sodium dodecyl benzene sulfonate, sodium sterate, potassium sterate, potassium myristate, tomadol, polyglyceryl sterate, glycol monosterate, potassium oleate, polyglyceryl oleate, tween, polymers, acrylic polymers, ethyl cellulous, carboxymethyl cellulose, sodium hydroxide, ammonium hydroxide, polyacrylate polymer, polyvinyl pyrolidane, lauric diethanolamine, dimethyldodecylamine oxide, aspartic acid tetrasodium salt, and sodium citrate.

In some embodiments, the composition comprises 1-50% of active ingredients. In some embodiments, the active ingredients are present at a concentration of 5-20%. In some embodiments, the composition comprises 14.8% active ingredients and 85.2% other ingredients.

In some embodiments, the pH is 3-12, the viscosity is 5-35 cP @ 100 rpms, the density is 0.1-2.5 g/ml, the cloud point superior is greater than 40 up to 120° C., and the cloud point inferior is between 40° C. to −55° C. In some embodiments, the pH is 5-9, the viscosity is 10-25 cP @ 100 rpms, the density is 0.4-1.2 g/ml, the cloud point superior is greater than 60 up to 100° C., and the cloud point inferior is between 20° C. to −35° C. In some embodiments, the pH is 7.64, the viscosity is 18.2 cP @ 100 rpms, the density is 0.84 g/ml, the cloud point superior is greater than 80° C., and the cloud point inferior is between −5° C. to −10° C.

In some embodiments, 0.1-50% of the pest-control composition of any of the preceding claims can be added to 50-90% of a base solution. In some embodiments, 0.1-15% of the pest-control composition is added to 85-99.9% base solution.

In some embodiments, the pest-control-composition is used to treat surfaces.

In some embodiments, the base solution comprises at least one of the two other ingredients.

In some embodiments, at least one active ingredient is selected from the group consisting of geraniol, nootketone and amyl cinnamaldehyde; and wherein the at least two other ingredients are selected from of the group consisting of 2-propanol, ethoxylated alcohol, sodium lauryl sulfate, and tomadol.

### BRIEF DESCRIPTION OF THE DRAWINGS

Those of skill in the art will understand that the drawings, described below, are for illustrative purposes only. The drawings are not intended to limit the scope of the present teachings in anyway.

FIG. 1 is a graph illustrating the mean percent repellency of different insect repellent treatments on Musca domestica at each evaluation time point.

FIG. 2 is a graph illustrating the mean percent repellency of different insect repellent treatments on Solenopsis invicta at each evaluation time point.

FIG. 3 is a graph illustrating the mean percent repellency of different insect repellent treatments on Blattella germanica at each evaluation time point.

FIG. 4 is a graph illustrating the mean percent repellency of different insect repellent treatments on Blattella germanica at each evaluation time point.

### DETAILED DESCRIPTION OF THE INVENTION

Unless otherwise noted, terms are to be understood according to conventional usage by those of ordinary skill in the relevant art.

The present invention relates to compositions and methods related to controlling insects.

In some embodiments, repellent surface cleaning/washing composition can be comprised of 14.8% Active Ingredient (AI) blend and 85.2% other ingredients. In some embodiments for consumer use 1.4% of the repellent surface cleaning/washing composition can be added to 98.6% base solution.

In some embodiments, repellent surface cleaning/washing composition can be comprised of 1-30% Active Ingredient (AI) blend. In other embodiments, repellent surface cleaning/washing composition can be comprised of 1-5%, 5-15%, 10-30%, 25-40%, or 10-50% Active Ingredient (AI) blend. In some embodiments, repellent surface cleaning/washing composition can be comprised of 70-99% other ingredients. In other embodiments, repellent surface cleaning/washing composition can be comprised of 90-99%, 80-95%, 70-90%, 60-75%, or 50-90% other ingredients. In some embodiments for consumer use, 0.1-15% of the repellent surface cleaning/washing composition can be added to 85-99.9% base solution. In other embodiments for consumer use, 1-5%, 5-15%, 10-30%, 25-40%, or 10-50% of the repellent surface cleaning/washing composition can be added to 90-99%, 80-95%, 70-90%, 60-75%, or 50-90% base solution.

Active Ingredients can include, but not be limited to, geraniol, nootketone, amyl cinnamaldehyde, catnip, wintergreen, carvacrol, d-limonene, orange oil, lauric acid, alpha pinene, mint, cornmint oil, lemon oil, eucalyptus, eugenol, peppermint, lemongrass oil, and terpenes.

Other ingredients can include, but not be limited to, 2-propanol, alcohol, ethanol, monobutyl ether, ethylene glycol, terpenes, ethoxylated alcohol, dodecanol, ammonia, soap, lauryl polyglucose, polyethylene glycol, sodium lauryl sulfate, sodium olefin sulfonate, cocamidapropyl betaine, alkylbenzene sulfonate, polyoxyethelene alkylphenol sulfate, sodium dodecyl benzene sulfonate, sodium sterate, potassium sterate, potassium myristate, tomadol, polyglyceryl sterate, glycol monosterate, potassium oleate, polyglyceryl oleate, tween, polymers, acrylic polymers, ethyl cellulous, carboxymethyl cellulose, sodium hydroxide, ammonium hydroxide, polyacrylate polymer, polyvinyl pyrolidane, lauric diethanolamine, dimethyldodecylamine oxide, aspartic acid tetrasodium salt, and sodium citrate.

Some AI blends and other ingredient blends are listed in Table 1 and Table 2, respectively. In some embodiments, the format can be liquid, the appearance can be clear, light yellow, the pH can be 7.64, the viscosity can be 18.2 cP @ 100 rpms, the density can be 0.84 g/ml, the cloud point superior can be >80° C., the cloud point inferior can be between −5° C. to −10° C., the odor can be light citrus/isopropyl alcohol, and it can be compatible with cationic and non-ionic surfactants, buffering agents, colors/dyes and perfumes. In other embodiments, the format can be liquid, the appearance can be clear, light yellow, the pH can be 5-9, the viscosity can be 10-25 cP @ 100 rpms, the density can be 0.4-1.2 g/ml, the cloud point superior can be >60-100° C., the cloud point inferior can be between 20° C. to −35° C., the odor can be light citrus/isopropyl alcohol, and it can be compatible with cationic and non-ionic surfactants, buffering agents, colors/dyes and perfumes. In other embodiments, the format can be liquid, the appearance can be clear, light yellow, the pH can be 3-12, the viscosity can be 5-35 cP @ 100 rpms, the density can be 0.1-2.5 g/ml, the cloud point superior can be >40-120° C., the cloud point inferior can be between 40° C. to −55° C., the odor can be light citrus/isopropyl alcohol, and it can be compatible with cationic and non-ionic surfactants, buffering agents, colors/dyes and perfumes.

TABLE 1

| | | Amount | | | |
|---|---|---|---|---|---|
| | | {total | | | |
| | | weight: | | Upper limit | Lower limit |
| Component | CAS# | 10,000 lbs} | % by Weight | % by Weight | % by Weight |
| Geraniol | 106-24-1 | 70.42 | 7.042 | 7.39 | 6.69 |
| Nootketone | 4674-30-4 | 7.042 | 0.704 | 0.739 | 0.669 |
| Amyl | 122-40-7 | 70.43 | 7.043 | 7.39 | 6.69 |
| Cinnamaldehyde | | | | | |
| Geraniol | 106-24-1 | 50.0-90.0 | 5.0-9.0 | 15.0 | 3.0 |
| Nootketone | 4674-30-4 | 5.0-9.0 | 0.5-0.9 | 1.5 | 0.3 |
| Amyl | 122-40-7 | 50.0-90.0 | 5.0-9.0 | 15.0 | 3.0 |
| Cinnamaldehyde | | | | | |
| Geraniol | 106-24-1 | 10.0-150.0 | 1.0-15.0 | 50.0 | 1.0 |
| Nootketone | 4674-30-4 | 1.0-15.0 | 0.1-1.5 | 5.0 | 0.1 |
| Amyl | 122-40-7 | 10.0-150.0 | 1.0-15.0 | 50.0 | 1.0 |
| Cinnamaldehyde | | | | | |

TABLE 2

| | | Amount | | | |
|---|---|---|---|---|---|
| | | {total weight: | | Upper limit | Lower limit |
| Component | CAS# | 10,000 lbs} | % by Weight | % by Weight | % by Weight |
| 2-Propanol | 67-63-0 | 703.22 | 70.422 | 72.5 | 68.3 |
| (isopropyl | | | | | |
| alcohol) | | | | | |
| Tomadol | 68439-46-3 | 147.89 | 14.789 | 15.53 | 14.05 |
| 2-Propanol | 67-63-0 | 600.0-800.0 | 60.0-80.0 | 80.0 | 60.0 |
| (isopropyl | | | | | |
| alcohol) | | | | | |
| Tomadol | 68439-46-3 | 100.0-200.0 | 10.0-20.0 | 20.0 | 10.0 |
| 2-Propanol | 67-63-0 | 500.0-990.0 | 50.0-99.0 | 99.0 | 50.0 |
| (isopropyl | | | | | |
| alcohol) | | | | | |
| Tomadol | 68439-46-3 | 50.0-300.0 | 5.0-30.0 | 30.0 | 5.0 |

The compositions disclosed herein include one or more “active” ingredients and two or more “other” ingredients in addition to the “active” ingredients. In some situations, ingredients that are not among the specified “active” ingredients are referred to as “inert” ingredients. In this usage, “inert” is a relative term, to contrast with the term “active.” However, such usage does not require or imply that the “inert” ingredients be truly inert chemically and/or biologically, but merely that they are not the ingredients specified to be “active.” Furthermore, such “other” or “inert” ingredients can indeed have an activity or contribute to or enhance the activity of the “active” ingredients, in some situations.

Having described the invention in detail, it will be apparent that modifications, variations, and equivalent embodiments are possible without departing the scope of the invention defined in the appended claims. Furthermore, it should be appreciated that all examples in the present disclosure are provided as non-limiting examples.

### EXAMPLES

The following non-limiting examples are provided to further illustrate embodiments of the invention disclosed herein. It should be appreciated by those of skill in the art that the techniques disclosed in the examples that follow represent approaches that have been found to function well in the practice of the invention, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the invention.

### Example 1

### Insect Repellent Surface Cleaning/Washing Composition Applied to Floor Tiles Repels House Flies

100 adult house flies (Musca domestica) were placed into the assay then exposed to treated bait stations, a control and test treatment. Fly response to the bait stations were recorded at predetermined time points with a video camera. Percent repellency was calculated and comparisons between treatments were made.

All test house fly specimens were taken from in-house laboratory reared colonies, and were confirmed alive and in good condition prior to testing. No specimens showing any visible signs of stress, physical damage or pathogen infection were used in the study. When applicable a 1:1 male to female sex ratio was used to ensure equal susceptibility.

The test arena was assembled and prepared prior to test initiation. The test arena consisted of a large 73.66 cm×73.66 cm×73.66 cm PVC frame work fitted with Thrips screening. At the top of the enclosed arena a USB powered video camera was suspended and centered over a 62.87 cm×62.87 cm section of white ceiling tile divided (marked with pencil) into equal quadrants.

The bait stations were constructed as follows: A ¼″ diameter hole was drilled in the center of a 10.8 cm by 10.8 cm white glazed clay tile. A 50 ml Falcon tube cap was affixed to the bottom of the tile over the hole to create a reservoir for the bait to be contained. Bait was pipetted into the reservoir then a cotton wick in inserted into the hole preventing flies from entering the reservoir and allowing bait to wick to the surface. The bait was at a 4:1:1 ratio of water, sugar, and coffee creamer.

The chemical application method was as follows: Material was pipette applied to tile surface and allowed approximately 1 hour to dry. The chemical volume applied was 348 μl. Fly specimens were exposed for 24 hours. Assays were performed with a minimum of three replicates. Test material descriptions and application rates are listed in Table 3. The Tyra Tech Insect repellent surface cleaning/washing composition was comprised of 14.8% Active Ingredient (AI) blend and 85.2% other ingredients.

TABLE 3

| | | Active | A.I. | Dilution Rate | A.I. After |
|---|---|---|---|---|---|
| | | Ingredient | Nominal | (Water) | Dilution |
| Treatment | | (A.I.) | (%) | Treatment:Water | (%) |
| 1 | Control - | N/A | N/A | N/A | N/A |
| | Water | | | | |
| 2 | Ajax ® Expel | N-methyl | 2% | 2 caps (200 ml)/liter - | 0.3333% |
| | | neodecanamide | | per label instructions | |
| 3 | FWB = soap | N/A | N/A | 1:20 | N/A |
| | solution | | | | |
| 4 | DEET | N/A | 0.21% | 1:10 | 0.0191% |
| 5 | TyraTech | geraniol, | 0.21% | Neat - no dilution | 0.2100% |
| | composition | nootketone, | | | |
| | | amyl | | | |
| | | Cinnamaldehyde | | | |
| 6 | TyraTech | geraniol, | 0.21% | 1:5 | 0.0350% |
| | composition | nootketone, | | | |
| | | amyl | | | |
| | | Cinnamaldehyde | | | |
| 7 | TyraTech | geraniol, | 0.21% | 1:10 | 0.0191% |
| | composition | nootketone, | | | |
| | | amyl | | | |
| | | Cinnamaldehyde | | | |
| 8 | TyraTech | geraniol, | 0.21% | 1:20 | 0.0100% |
| | composition | nootketone, | | | |
| | | amyl | | | |
| | | Cinnamaldehyde | | | |

It was confirmed that video cameras were appropriately viewing the center of the ceiling tile with a computer and computer program (such as WinCam). Flies were anesthetized with CO₂ and then 100 flies were placed into a clean container. Insects were allowed to recover and acclimate to testing conditions for 1 hour prior to test initiation by placing and opening container with flies into assembled assay arena and allowing flies to disperse. All surfaces of bait station were cleaned with ethanol and allowed to dry. A pipette were used to treat the tile surface with the test material and treatment was spread over entire surface with pipette tip; material was allowed to dry for approximately 1 hour prior to test initiation. When dry, 5 ml of bait was pipetted into the reservoir. A cotton wick was inserted into the hole to ensuring that the top of the wick sits flush with the tile surface. A treated and a control bait station was placed into the test arena, one each centered within a randomly designated quadrant opposite of each other into a testing arena. Cameras were allowed to capture fly response over a 24 hour time period. Images were transferred to computer and data were analyzed.

Photos were taken at each of the following time points: 15 minutes, 30 minutes, 1, 2, 3, 4, 5, 6, 7, 8, 12, 18 and 24 hours post introduction of treatment. At the conclusion of the test the image files were reviewed and the number of flies at each bait station was counted and recorded for both treatment and control.

Average percent repellency was used as a standard measure of repellency of the treatments against insect species. Percent repellency was calculated for each treatment replicate by the following formula:

$$Percent Repellency = \frac{( \begin{matrix}No . insects on negative control - \\ No . insects on treatment\end{matrix} )}{No . insects on negative control} \times 100$$

Mean percent repellency for each treatment based on the data of the replicates at the given observation time points:

$$Mean Percent Repellency = \frac{( \begin{matrix}\% repellency rep . 1 + \\ \% repellency rep . 2 + \% repellency rep . \times …\end{matrix} )}{No . of replicate}$$

Repellency between treatments was then compared using SAS version 9.3 to calculate the repeated measures ANOVA with time as repeated measure. Tukey's correction was used to ensure a remained at 0.05.

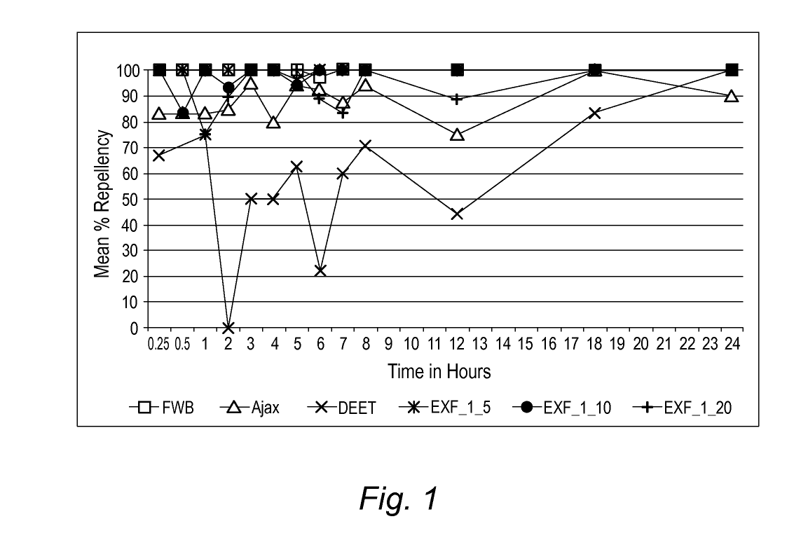

The mean percent repellency at each evaluation time point for Ajax Expel, Deet and three dilutions of TyraTech Insect repellent surface cleaning/washing composition against house flies are shown in Tables 4-5 and FIG. 1. TyraTech Insect repellent surface cleaning/washing composition—a high level of repellency (an average of 99.7% at 1:5, 97.8 at 1:10 and 94.3% at a 1:20 dilution) was observed over 24 hours vs. house flies. Ajax Expel averaged 10% less repellent than TyraTech Insect repellent surface cleaning/washing composition at any concentration however, no statistically significant differences between these treatments was calculated. DEET at the concentrations tested was significantly less repellent than any other treatment.

TABLE 4

| | Treatment | | | | | |
|---|---|---|---|---|---|---|
| Time | FWB | Ajax | DEET | EXF_1_5 | EXF_1_10 | EXF_1_20 |
| 0.25 | 100.0 | 83.3 | 66.7 | 100.0 | 100.0 | 100.0 |
| 0.5 | 100.0 | 83.3 | — | 100.0 | 83.3 | 100.0 |
| 1 | 100.0 | 83.3 | 75.0 | 100.0 | 100.0 | 75.0 |
| 2 | 100.0 | 84.7 | 0.0 | 100.0 | 93.3 | 89.6 |
| 3 | 100.0 | 95.2 | 50.0 | 100.0 | 100.0 | 100.0 |
| 4 | 100.0 | 80.0 | 50.0 | 100.0 | 100.0 | 100.0 |
| 5 | 100.0 | 94.4 | 62.5 | 96.3 | 94.4 | 100.0 |
| 6 | 97.4 | 92.6 | 22.2 | 100.0 | 100.0 | 88.9 |
| 7 | 100.0 | 87.5 | 60.0 | 100.0 | 100.0 | 83.3 |
| 8 | 100.0 | 94.4 | 70.6 | 100.0 | 100.0 | 100.0 |
| 12 | 100.0 | 75.0 | 44.4 | 100.0 | 100.0 | 88.9 |
| 18 | 100.0 | 100.0 | 83.3 | 100.0 | 100.0 | 100.0 |
| 24 | 100.0 | 90.0 | 100.0 | 100.0 | 100.0 | 100.0 |

TABLE 5

| | FWB | Ajax | DEET | EXF_1_5 | EXF_1_10 | EXF_1_20 |
|---|---|---|---|---|---|---|
| Average mean percent | 99.8 | 88.0 | 57.1 | 99.7 | 97.8 | 94.3 |
| repellency over 24 hours | | | | | | |
| Median mean percent | 100.0 | 87.5 | 61.3 | 100.0 | 100.0 | 100.0 |
| repellency over 24 hours | | | | | | |

### Example 2

### Ant Surface Repellent Bioassay

A medium sized Red imported ant (Solenopsis invicta) colony>500 individuals containing at least one queen was placed into a Fluon treated plastic container. Ants were acclimated to laboratory testing conditions over a 72 hour period and must exhibit normal colony behavior prior to testing. Floor wash treatments were applied to cleaned ceramic tiles and left to dry before bait is added to the center of the tile. Ant response to treatments was evaluated at the predetermined time points.

All specimens were field collected 1 week prior to testing, and were confirmed alive and in good condition prior to testing. No specimens showing any visible signs of stress, physical damage or pathogen infection were used in the study. When applicable a 1:1 male to female sex ratio was used to ensure equal susceptibility.

The test arena was assembled and prepared prior to test initiation. The test arena was a Fluon treated (to prevent escape) of a 60.9 cm×30.5 cm×30.5 cm plastic tub. An ant colony containing at least one queen was placed at one end of the container. The colony was provided food and water and would remain in the arena undisturbed for a minimum of 72 hours prior to test initiation.

Ant counts were taken at each of the following time points: every 30 minutes to 5 hours and at 22 and 24 hours post introduction of treatment. At the conclusion of the test, the number of ants at each bait station was counted for both treatment and control for each evaluation time point.

The chemical application method was as follows: Material was pipette applied to tile surface and allowed approximately 1 hour to dry. The chemical volume applied is 350 μl. Fly specimens were exposed for 24 hours. Assays were performed with a minimum of three replicates. Test material descriptions and application rates are listed in Table 3. The Tyra Tech Insect repellent surface cleaning/washing composition was comprised of 14.8% Active Ingredient (AI) blend and 85.2% other ingredients.

The testing was on a cleaned and dried 10.75 cm×10.75 cm white glazed ceramic tile. The bait was a 10% sugar water solution.

Tiles were cleaned with ethanol and allow to dry. A pipette was used to treat the tile surface with the test material and treatment was spread over the entire surface with pipette tip; material was allowed to dry for approximately 1 hour prior to test initiation. Two treatment stations were placed side by side (one with test material and one control) in a randomly selected test arena and orientation. The number of ants present on each tile was recorded at the predetermined time intervals using a mechanical counter. When the test was concluded the treatment stations were removed and the data were analyzed.

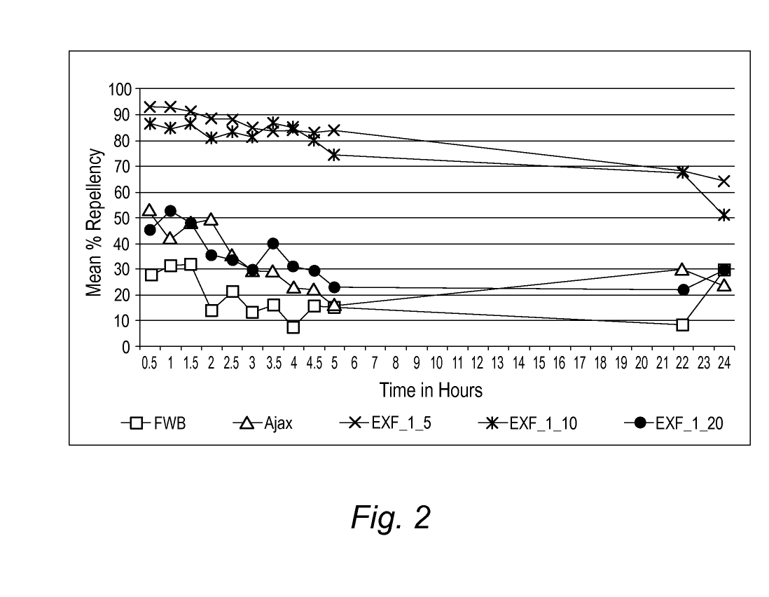

The mean percent repellency at each evaluation time point for the floor wash base alone, Ajax Expel, and three dilutions (1:5, 1:10 and 1:20) of TyraTech Insect repellent surface cleaning/washing composition against fire ants are shown in Tables 6-7 and FIG. 2.

TyraTech Insect repellent surface cleaning/washing composition at a 1:5 and 1:10 dilution rate were statistically significantly more repellent than Ajax Expel. The TyraTech Insect repellent surface cleaning/washing composition at a 1:5 and 1:10 dilution rate demonstrated an average of 84% and 79% repellency against fire ants respectively over the 24 hour evaluation.

TABLE 6

| Time in | Treatment | | | | |
|---|---|---|---|---|---|
| Hours | FWB | Ajax | EXF_1_5 | EXF_1_10 | EXF_1_20 |
| 0.5 | 28.0 | 52.8 | 93.3 | 86.7 | 45.3 |
| 1 | 31.2 | 42.2 | 93.0 | 85.0 | 52.8 |
| 1.5 | 31.6 | 47.9 | 91.3 | 87.0 | 48.1 |
| 2 | 13.7 | 49.5 | 88.8 | 81.1 | 35.3 |
| 2.5 | 20.9 | 35.5 | 88.1 | 83.7 | 33.3 |
| 3 | 13.0 | 29.2 | 85.1 | 81.5 | 29.8 |
| 3.5 | 15.9 | 28.9 | 83.5 | 87.1 | 39.8 |
| 4 | 7.3 | 22.6 | 84.4 | 85.3 | 31.1 |
| 4.5 | 15.3 | 22.2 | 83.3 | 80.3 | 29.2 |
| 5 | 14.9 | 16.2 | 84.0 | 74.8 | 22.7 |
| 22 | 8.2 | 30.0 | 68.1 | 67.5 | 21.9 |
| 24 | 29.7 | 23.6 | 64.2 | 51.2 | 29.9 |

TABLE 7

| | FWB | Ajax | EXF_1_5 | EXF_1_10 | EXF_1_20 |
|---|---|---|---|---|---|
| Average mean | 19.1 | 33.4 | 83.9 | 79.3 | 34.9 |
| percent | | | | | |
| repellency over | | | | | |
| 24 hours | | | | | |
| Median mean | 15.6 | 29.6 | 84.7 | 82.6 | 32.2 |
| percent | | | | | |
| repellency over | | | | | |
| 24 hours | | | | | |

### Example 3

### Cockroach Surface Repellent Bioassay

German cockroaches (Blattella germanica) were evaluated using a harborage choice test. Forty cockroaches were placed in a 10 gallon glass arena. Two harborages constructed of ceramic tiles were treated and placed into the arena. Food and water was provided between the harborage stations and cockroaches were evaluated for repellency at designated time points.

All cockroach specimens were taken from in-house laboratory reared colonies, and were confirmed alive and in good condition prior to testing. No specimens showing any visible signs of stress, physical damage or pathogen infection were used in the study. When applicable a 1:1 male to female sex ratio was used to ensure equal susceptibility.

A 10 gallon glass aquarium was cleaned with ethanol. A thin layer of “grease” (2:3 ratio of petroleum jelly:mineral oil) was applied to the inside of all walls (top to bottom) with a paper towel to prevent escape. One untreated harborage was placed in the center of each half of the tank and food and water was placed between the two harborages.

Eight pieces of the same surface material and dimensions (i.e. glazed tiles, hardwood flooring, etc.) were used to prepare the harborages for one test arena. The harborage units were assembled by hot gluing four hex nuts (one in each corner) to the top surface of a ceramic tile. A second tile was placed face down onto the hex nuts creating a small space for the cockroaches to inhabit. This was repeated with the remaining surface material and hex nuts to create four harborages. Two remained untreated and used during acclamation and the other two were used during treatments. Each surface of the inside of the harborage (top and bottom) was treated with 350 μl of material. The material was spread evenly over the entire surface with tip of a pipette then allowed to dry for 1 hour prior to test initiation. Placement of treatments was randomly assigned to both arena and position in arena. Test material descriptions and application rates are listed in Table 3. The Tyra Tech Insect repellent surface cleaning/washing composition was comprised of 14.8% Active Ingredient (AI) blend and 85.2% other ingredients.

Exposure time was 24 hours, with a 12:12 light cycle. Evaluations were only made during light cycle; two test groups with evaluations at 1, 4, 8, 12 and 12, 16, 20, 24 hours. At the evaluation points the number of cockroaches under each harborage were recorded as well as the number of cockroaches roaming and any dead cockroaches. Assays were performed with a minimum of three replicates.

Cockroaches were anesthetized with CO₂ and 40 roaches were placed in a 1:1 sex ratio into a clean container. Cockroaches were introduced into assembled test arena and acclimated to test conditions for 24 hours prior to test initiation. All surfaces of treatment station were cleaned with ethanol and allow to dry. Harborages were treated with 350 μl of test material on both top and bottom of harborage unit and allowed to dry for 1 hour. Untreated harborages in test arenas were replaced with the treated harborages according to the randomization table. The number of insects present on each tile was recorded at the predetermined time intervals using a mechanical counter.

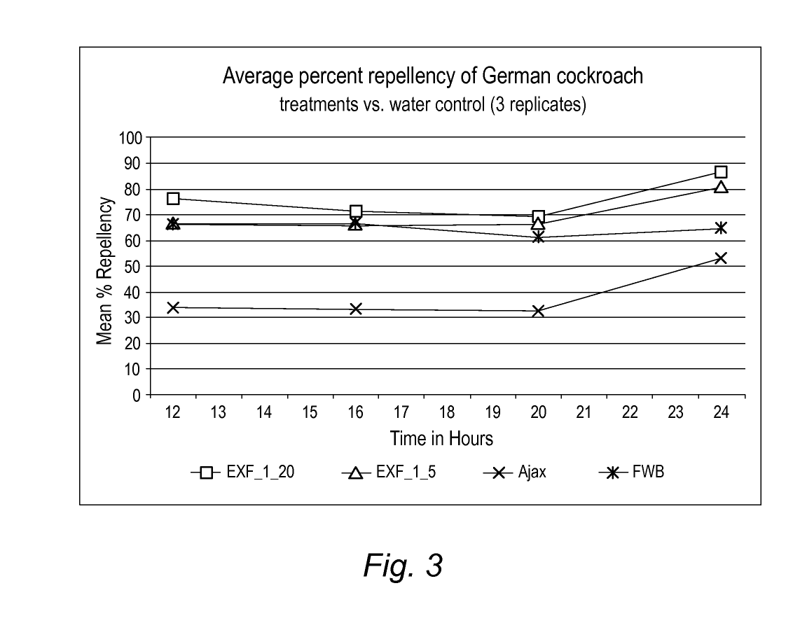

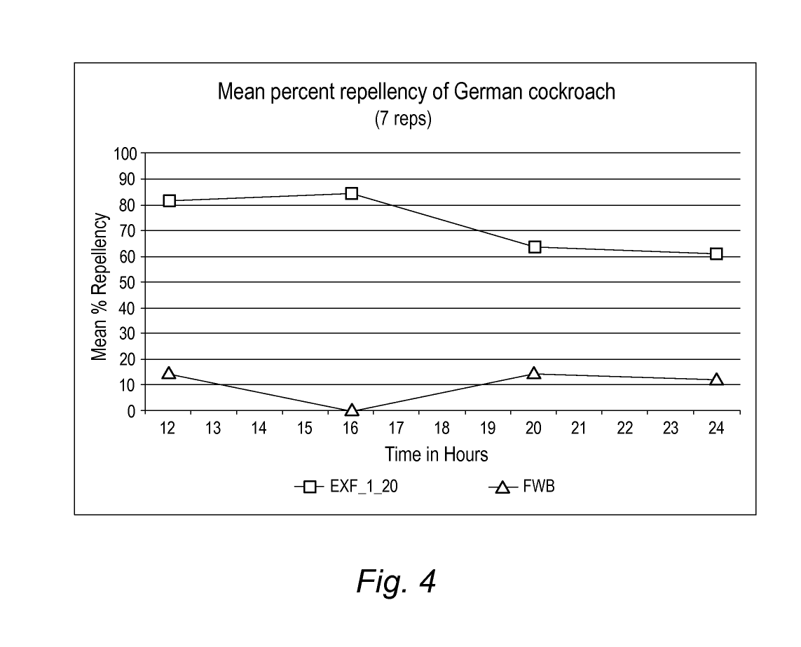

The mean percent repellency at each evaluation time point for the floor wash base alone, Ajax Expel, and three dilutions (1:5, 1:10 and 1:20) of Tyra Tech Insect repellent surface cleaning/washing composition against fire ants are shown in Tables 8-9 and FIGS. 3-4.

TABLE 8

| | Treatment | | | |
|---|---|---|---|---|
| Time | EXF_1_20 | EXF_1_5 | Ajax | FWB |
| 12 | 76.2 | 66.7 | 33.3 | 66.7 |
| 16 | 71.3 | 66.7 | 33.3 | 66.7 |
| 20 | 68.6 | 66.7 | 32.2 | 61.1 |
| 24 | 86.7 | 80.8 | 52.8 | 64.6 |
| Average mean | 75.7 | 70.2 | 37.9 | 64.8 |
| percent 12-24 hours | | | | |

TABLE 9

Treatment

| Time | EXF_1_20 | FWB |
|---|---|---|
| 12 | 81.2 | 14.3 |
| 16 | 83.9 | 0.0 |
| 20 | 63.1 | 14.0 |
| 24 | 60.5 | 11.8 |
| Average mean | 72.2 | 10.0 |
| percent 12-24 hours | | |

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A pest-control composition comprising at least one active ingredient and at least two other ingredients;
wherein the at least one active ingredient is selected from the group consisting of geraniol, nootketone, amyl cinnamaldehyde, catnip, wintergreen, carvacrol, d-limonene, orange oil, lauric acid, alpha pinene, mint, cornmint oil, lemon oil, eucalyptus, eugenol, peppermint, lemongrass oil, and terpenes; and
wherein the at least two other ingredients are selected from the group consisting of 2-propanol, alcohol, ethanol, monobutyl ether, ethylene glycol, terpenes, ethoxylated alcohol, dodecanol, ammonia, soap, lauryl polyglucose, polyethylene glycol, sodium lauryl sulfate, sodium olefin sulfonate, cocamidapropyl betaine, alkylbenzene sulfonate, polyoxyethelene alkylphenol sulfate, sodium dodecyl benzene sulfonate, sodium sterate, potassium sterate, potassium myristate, tomadol, polyglyceryl sterate, glycol monosterate, potassium oleate, polyglyceryl oleate, tween, polymers, acrylic polymers, ethyl cellulous, carboxymethyl cellulose, sodium hydroxide, ammonium hydroxide, polyacrylate polymer, polyvinyl pyrolidane, lauric diethanolamine, dimethyldodecylamine oxide, aspartic acid tetrasodium salt, and sodium citrate.

2. The composition of claim 1 where in the composition comprises 1-50% of active ingredients.

3. The composition of claim 2 wherein active ingredients are present at a concentration of 5-20%.

4. The composition of claim 2 where in the composition comprises 14.8% active ingredients and 85.2% other ingredients.

5. The composition of claim 1 wherein the pH is 3-12, the viscosity is 5-35 cP @ 100 rpms, the density is 0.1-2.5 g/ml, the cloud point superior is greater than 40 up to 120° C., and the cloud point inferior is between 40° C. to −55° C.

6. The composition of claim 5, wherein the pH is 5-9, the viscosity is 10-25 cP @ 100 rpms, the density is 0.4-1.2 g/ml, the cloud point superior is greater than 60 up to 100° C., and the cloud point inferior is between 20° C. to −35° C.

7. The composition of claim 6 wherein the pH is 7.64, the viscosity is 18.2 cP @ 100 rpms, the density is 0.84 g/ml, the cloud point superior is greater than 80° C., and the cloud point inferior is between −5° C. to −10° C.

8. A pest-control formulation wherein 0.1-50% of the pest-control composition of claim 1 can be added to 50-90% of a base solution.

9. The pest-control formulation of claim 8 wherein the 0.1-15% of the pest-control composition is added to 85-99.9% base solution.

10. The formulation of claim 8, wherein the formation is used to treat surfaces.

11. The formulation of claim 8, wherein the base solution comprises at least one of the two other ingredients.

12. The composition of claim 1 wherein the at least one active ingredient is selected from the group consisting of geraniol, nootketone and amyl cinnamaldehyde; and wherein the at least two other ingredients are selected from of the group consisting of 2-propanol, ethoxylated alcohol, sodium lauryl sulfate, and tomadol.
